(19) United States
(12) Patent Application Publication
(10) Pub. No.: US 2015/0015406 A1
(43) Pub. Date: Jan. 15, 2015

(54) CAUTION SIGN DEVICE

(71) Applicant: Rick Charles FURTADO, North Wales, PA (US)

(72) Inventor: Rick Charles FURTADO, North Wales, PA (US)

(21) Appl. No.: 14/330,638

(22) Filed: Jul. 14, 2014

Related U.S. Application Data
(60) Provisional application No. 61/846,198, filed on Jul. 15, 2013.

(51) Int. Cl. G08B 7/06

(52) U.S. Cl. CPC G08B 7/06
USPC 340/691.5

(57) ABSTRACT

A caution sign device is provided. The caution sign device may be designed for warning pedestrians of potentially hazardous conditions nearby. The caution sign device may include a body having a lighting assembly, a timer, a sound system, a power source and a motion detector integrated thereto.

### CROSS-REFERENCE TO RELATED APPLICATION

This application claims the benefit of priority of U.S. provisional application No. 61846198, filed 15 Jul. 2013, the contents of which are herein incorporated by reference.

### BACKGROUND OF THE INVENTION

The present invention relates to signs and, more particularly, to a sign device that actively cautions pedestrians travelling nearby.

Currently, people ignore and walk past wet floor signs because they are simply part of the scenery. As a result, pedestrians travelling on floors with potentially hazardous surface conditions may never perceive the warnings of current wet floor signs.

As can be seen, there is a need for a sign device that refuses to be ignored when cautioning pedestrians travelling nearby.

### SUMMARY OF THE INVENTION

In one aspect of the present invention, a sign device for providing an undeniable warning, comprises: a body; a lighting assembly integrated with the body; a sound system integrated with the body; a motion detector integrated with the body, wherein the motion detector is electrically connected to the lighting assembly and the sound system; and a timer integrated with the body, wherein the timer is electromechanically connected to a power source.

In another aspect of the present invention, a method of conveying an undeniable warning messages for varying work environments, comprises: providing a sign device having a body, wherein the body is adapted to removably connect to various, pre-existing supporting surfaces; a lighting assembly integrated with the body; a sound system integrated with the body, wherein the sound system is configured to record, delete and play back a plurality of audible signals; a motion detector integrated with the body, wherein the motion detector is electrically connected to the lighting assembly and the sound system; and a timer integrated with the body, wherein the timer is electromechanically connected to a power source; recording on the sound system an audible warning message specifically for a first working environment; removably connecting the body to the pre-existing supporting surface specifically for the first working environment; and setting the timer for a duration of time.

In yet another aspect of the present invention, a sign device for providing an undeniable warning, comprises: a body, wherein the body is adaptable to removably connect to various, pre-existing supporting surfaces; a lighting assembly integrated with the body, wherein the lighting assembly is configured to produce lighting effects; a sound system integrated with the body, wherein the sound system is configured to record, delete and play back a plurality of audible signals and wherein the sound system comprises: a microphone, wherein the microphone is configured for receiving the plurality of audible signals; and at least one speaker, wherein the at least one speaker is configured for playing back the plurality of audible signals; a motion detector integrated with the body, wherein the motion detector is electrically connected to the lighting assembly and the sound system, and wherein the motion detector is configured for detecting motion from a nearby pedestrian so as to activate the lighting assembly and the sound system when nearby pedestrian motion is detected; a timer integrated with the body, wherein the timer is electromechanically connected to a power source; and a chirper is configured to provide an audible sound when the power source provides a predetermined range of power.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention; and

FIG. 2 is a front view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a caution sign device. The caution sign device may be designed for warning pedestrians of potentially hazardous conditions nearby. The caution sign device may include a body having a lighting assembly, a timer, a sound system, a power source and a motion detector integrated thereto.

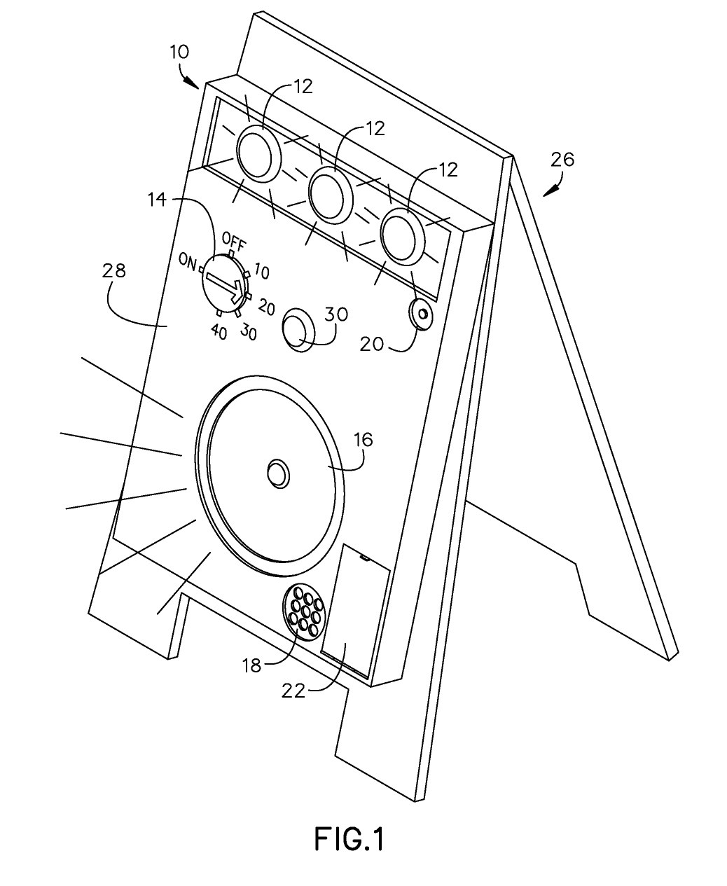

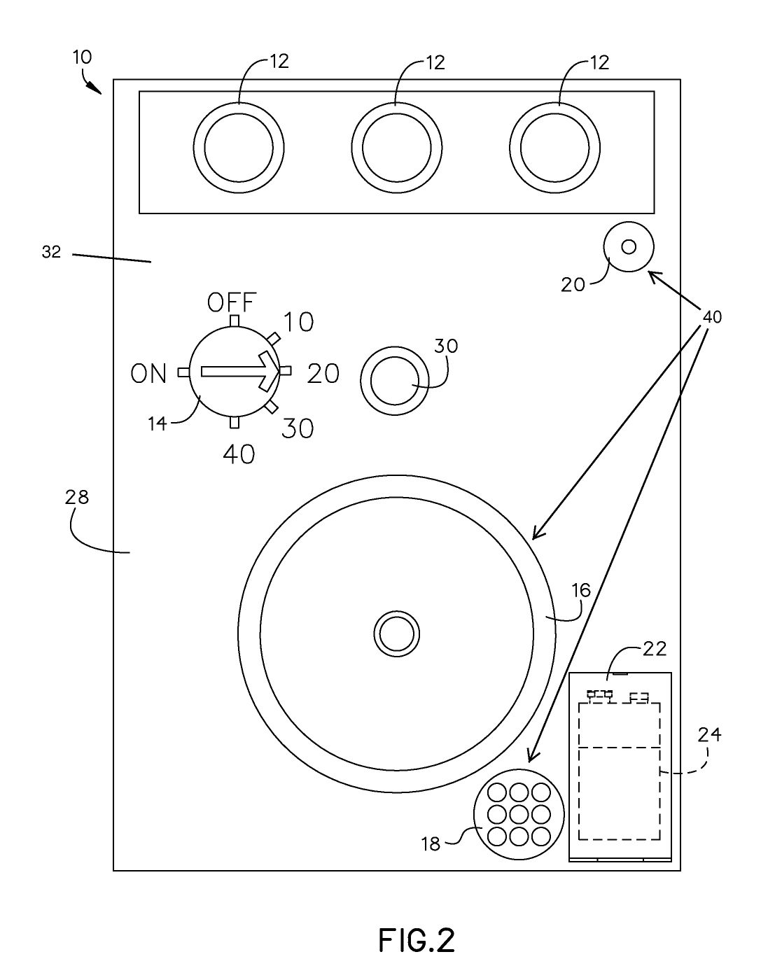

Referring to FIGS. 1 and 2, the present invention may include a caution sign device 10 designed for warning pedestrians of potentially hazardous conditions nearby. The caution sign device 10 may include a body 28 having a lighting assembly 12, a timer 14, a sound system 40, a power source 24 and a motion detector 30 connected and/or integrated thereto.

The body 28 may be generally rectangular in configuration and may have a generally planar face side 32. Though, the body 28 may be circular, oval, square, triangular or other geometric shapes as long as the body 28 functions in accordance with the present invention as described herein.

The body 28 may have a back side adapted to removably attach to various support surfaces. One such support surface may include two pivotably connected generally rectangular panels 26, as illustrated in FIG. 1. In certain embodiments, the two panels 26 each have a bottom edge forming a spaced apart pair of resting feet. In use, the caution sign device 10 may be removably attached to a wide array of two panels 26, which may have specific dimensions as a function of their different purposes (wet floor conditions as compared to the presence of hazardous substances) and/or use in conformity with different industry standards (e.g., OSHA standards concerning food service as compared with the FDA standards concerning pharmaceutical productions).

In other embodiments, the support surface may include a door, wall and/or the like that the body 28 removably attaches to. In an alternative embodiment, the body 28 may lean up against the support surface.

The lighting assembly 12 may include a plurality of light sources, such as light-emitting diodes (LEDs), fiber optic lights or the like. The lighting assembly 12 may be disposed along a portion of the body 28 so as not to be ignored by nearby pedestrians. The lighting assembly 12 may be configured to produce strobing, flashing, pulsing or the like light effects.

The sound system 40 may include at least one speaker 16 and a microphone 20. The sound system 40 may be designed for recording, playing back and deleting a plurality of audible signals, such an audible warning messages. The microphone 20 is for receiving the plurality of audible signals. The at least one speaker 16 is for audibly projecting played recorded sounds, such as the audible warning messages. The sound system 40 preferably has a recording button for activating the sound system 40 to record the audible warning messages. The audible warning messages may be very detailed instructions for how to best proceed through a hazardous environment. In certain embodiments, the sound system 40 may be configured to produce alarming noises at a decibel level that may be perceived as pain by a nearby pedestrian.

In certain embodiments, the audible warning messages may be produced at a volume sufficient to be heard under a, for example, a laminer flow hood. Moreover, the audible warning messages may be adapted to conform to the different cautionary characteristics required in different settings; by way of example, in the pharmaceutical industry the audible warning messages may be a different set of instruction for a nearby individual to carry out to satisfy the FDA requires associate with a Code A as compared to a Code B area of pharmaceutical productions.

A motion detector 30 for detecting motion from a nearby pedestrian is provided on a portion of the body 28. The motion detector 30 may be electrically connected to the lighting assembly 12 and the sound system 40. In use, when the motion detector 30 detects motion from a nearby pedestrian, the lighting assembly 12 is activated to illuminate and to flash and the sound system 40 is activated to project an audible prerecorded warning messages.

The body 28 provides a power source 24. The power source 24 may be a rechargeable or non-rechargeable battery or any other known power source. The power source may be retained within a power compartment 22, having a pivotably connected cover. The power source 24 may be electrically connected to the lighting assembly 12 for providing electrical power to the lighting assembly 12 and all elements electrically connected thereto. The power source 24 may include a chirper 18 or low power indicator. The chirper 18 may be adapted to produce an audible sound when the power source 24 is running low on available power.

The timer 14 may be configured to set a duration of time in which the caution sign device 10 is operable. The timer 14 may be electromechanically connected to the power source 24 so that after the duration of time expires, the electrical operations of the caution sign device 10 temporarily ceases, so as to conserve the power source 24 and/or prevent unnecessary warning signals.

A method of using the present invention may include the following. The caution sign device 10 disclosed above may be provided. A user may record an audio warning through the microphone 20. Then the user may set the timer 14 for the desired duration of time. The user may then removably secure the body 28 to, for example, the supporting surface of the two panels 26. Then the user may place the two panels 26 near a floor surface with conditions that approaching pedestrians would reasonably need to be apprised of for the desired duration of time.

It should be understood, of course, that the foregoing relates to exemplary embodiments of the invention and that modifications may be made without departing from the spirit and scope of the invention as set forth in the following claims.

What is claimed is:

1. A sign device for providing an undeniable warning, comprising:
a body;
a lighting assembly integrated with the body;
a sound system integrated with the body;
a motion detector integrated with the body, wherein the motion detector is electrically connected to the lighting assembly and the sound system; and
a timer integrated with the body, wherein the timer is electromechanically connected to a power source.

2. The sign device of claim 1, wherein the lighting assembly is configured to produce lighting effects.

3. The sign device of claim 1, wherein the sound system is configured to record, delete and play back a plurality of audible signals.

4. The sign device of claim 1, wherein the sound system provides a microphone.

5. The sign device of claim 4, wherein the microphone is configured for receiving the plurality of audible signals.

6. The sign device of claim 1, wherein the sound system provides at least one speaker.

7. The sign device of claim 6, wherein the at least one speaker is configured for playing back the plurality of audible signals.

8. The sign device of claim 1, wherein the motion detector is configured for detecting motion from a nearby pedestrian so as to activate the lighting assembly and the sound system when nearby pedestrian motion is detected.

9. The sign device of claim 1, further providing a chirper, wherein the chirper is configured to provide an audible sound when the power source provides a predetermined range of power.

10. The sign device of claim 1, wherein the body is adaptable to removably connect to various, pre-existing supporting surfaces.

11. The sign device of claim 10, wherein the pre-existing supporting surfaces are two pivotably connected panels.

12. A method of conveying an undeniable warning messages for varying work environments, comprising:
providing a sign device having a body, wherein the body is adapted to removably connect to various, pre-existing supporting surfaces; a lighting assembly integrated with the body; a sound system integrated with the body, wherein the sound system is configured to record, delete and play back a plurality of audible signals; a motion detector integrated with the body, wherein the motion detector is electrically connected to the lighting assembly and the sound system; and a timer integrated with the body, wherein the timer is electromechanically connected to a power source;
recording on the sound system an audible warning message specifically for a first working environment;
removably connecting the body to the pre-existing supporting surface specifically for the first working environment; and
setting the timer for a duration of time.

13. The method of claim 12, further including removing the body from the pre-existing supporting surface specifically for the first working environment after the duration of time, and further including recording on the sound system a second audible warning message specifically for a second working environment, and further including removably connecting the body to the pre-existing supporting surface specifically for the second working environment.

14. A sign device for providing an undeniable warning, comprising:
a body, wherein the body is adaptable to removably connect to various, pre-existing supporting surfaces;
a lighting assembly integrated with the body, wherein the lighting assembly is configured to produce lighting effects;
a sound system integrated with the body, wherein the sound system is configured to record, delete and play back a plurality of audible signals and wherein the sound system comprises:
a microphone, wherein the microphone is configured for receiving the plurality of audible signals; and
at least one speaker, wherein the at least one speaker is configured for playing back the plurality of audible signals;
a motion detector integrated with the body, wherein the motion detector is electrically connected to the lighting assembly and the sound system, and wherein the motion detector is configured for detecting motion from a nearby pedestrian so as to activate the lighting assembly and the sound system when nearby pedestrian motion is detected;
a timer integrated with the body, wherein the timer is electromechanically connected to a power source; and
a chirper is configured to provide an audible sound when the power source provides a predetermined range of power.

15. The sign device of claim 14, wherein the pre-existing supporting surfaces are two pivotably connected panels.
